(19) United States
(12) Patent Application Publication
(10) Pub. No.: US 2012/0198753 A1
(43) Pub. Date: Aug. 9, 2012

(54) Fabric shell waterfowl decoy

(76) Inventor: Peter J. Idstrom, Salt Lake City, UT (US)

(21) Appl. No.: 13/385,174

(22) Filed: Feb. 6, 2012

Related U.S. Application Data
(60) Provisional application No. 61/462,975, filed on Feb. 9, 2011.

(51) Int. Cl. A01M 31/06

(52) U.S. Cl. 43/3

(57) ABSTRACT

A decoy is provided containing a shell style fabric body mounted on a flat vertically oriented horizontal member. The bottom portion of the fabric shell body is supported with a semi-rigid band extending the circumference of the body shell, forming an open bottomed shell shape. The front and back portions of the shell style fabric body are fastened to the horizontal member. A vertically oriented flat head structure is connected to the horizontal member with a rigid wire support containing a connective coil end. The coil end is threaded through a vertical ground stake. The vertical ground stake is positioned at a perpendicular angle in relation to the horizontal member near the front of the decoy and is attached by inserting it through the member. The vertical ground stake is employed to support the decoy as it is mounted into the ground.

### CROSS-REFERENCE TO RELATED APPLICATIONS

This application claims the benefit of Provisional Patent Application 61/462,975, filed on Feb. 9, 2011 by the inventor.

### FEDERALLY SPONSORED RESEARCH

Not applicable

### SEQUENCE LISTING OR PROGRAM

Not applicable

### BACKGROUND OF THE INVENTION

1. Field of Invention

This invention generally relates to waterfowl hunting decoys, specifically to the use of a fabric shell style decoy with an improved body shape that will not collect precipitation inside the decoy body while in use.

2. Prior Art

Both fabric covered and plastic waterfowl decoys are popularly used by hunters to create the illusion of resting or feeding waterfowl for the purpose of attracting waterfowl within shotgun range. The use of fabric in hunting decoys allows the user to utilize a lightweight and realistic impression of a waterfowl. Previous fabric decoys have employed a windsock style bag to simulate the body shape of the waterfowl. These decoys are commonly referred to as “wind sock” style decoys. The windsock style decoy employs a sock design, which is a closed fabric bag, to capture the wind, which enhances the appearance of the decoy. Windsock style decoys tend to also capture and collect precipitation, such as snow or rain, during inclement weather. As a result, the windsock is weighed down by the precipitation, reducing their ability to move with the wind, and thus their overall effectiveness.

Molded plastic material is also currently used to produce waterfowl decoys. Shell style decoys using plastic for the body material are rigid in appearance. Additionally, plastic molded waterfowl decoys are relatively heavy and bulky when they are compared to a fabric decoy. They also employ a separate stake and body for each decoy, making transportation, storage, extra weight, and assembly a challenge for hunters.

U.S. Pat. No. 6,745,510 to Coker et al discloses a stackable plastic shell style decoy made of plastic with a removable and separately stored anchoring device.

U.S. Pat. No. 4,651,457 to Nelson et al features a windsock style decoy with a rigidly affixed head. The closed style windsock is subject to filling with precipitation, thus reducing the effectiveness of the decoy.

U.S. Pat. No. 5,172,506 to Tiley et al discloses a decoy having a head permanently mounted on top of a windsock type body, which is again subject to collecting precipitation.

U.S. Pat. No. 4,928,418 to Stelly et al discloses a closed cell foam body surrounding a wire frame with a hole 208 located on the top of the foam body to allow for air to escape. There is no provision disclosed which would allow for precipitation to exit the body of the decoy.

U.S. Pat. No. 7,028,429 to Druliner et al discloses a windsock style body on a head, neck, and arm apparatus supported by a bent wire stake, which is then inserted into the ground by the means of a tube. The windsock style body is subject to filling with precipitation during use.

3. Objects and Advantages

Accordingly, the objects and advantages of my invention are I have invented a realistic and lightweight fabric body waterfowl decoy that will not collect precipitation inside the body during use. The decoy offers the user the appearance of a full body windsock decoy, with the advantage of an open bottom and life-like appearance. The open bottom of the decoy also captures wind, which aids the appearance and movement of the decoy. Additionally, the shell style body of the decoy is rotatable for the purpose of storage. Further objects and advantage will become apparent upon further review of the drawings and ensuing descriptions.

### SUMMARY

The invention presented provides users with a shell style fabric body decoy, with a supporting structure, a separate and adjustable head, a means of compact storage, with an open bottom to prevent precipitation accumulation within the decoy body. The open bottom of the invention facilitates the capture of wind for the purpose of enhancing the appearance and movement of the decoy as well.

### DRAWINGS

### Figures

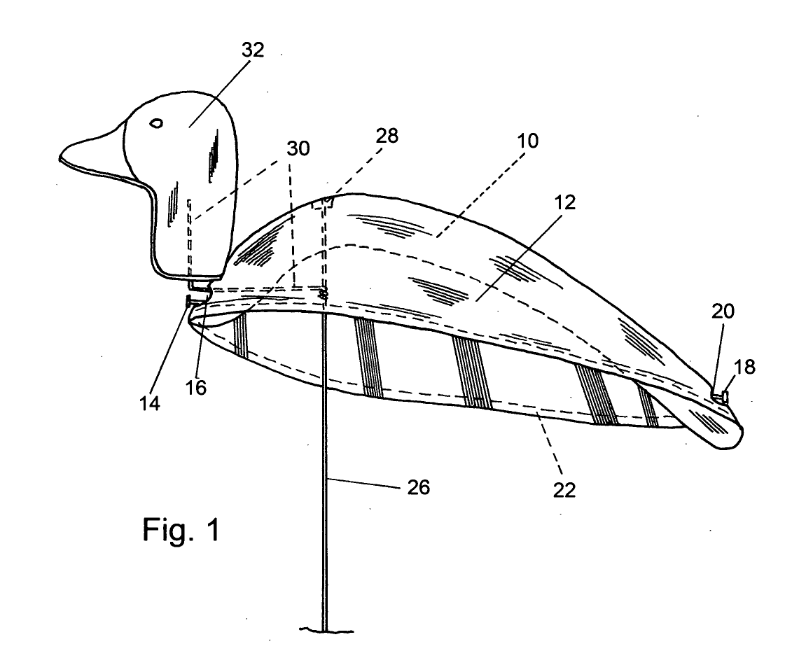

FIG. 1 is a perspective view of the invention as operably anchored in the ground surface.

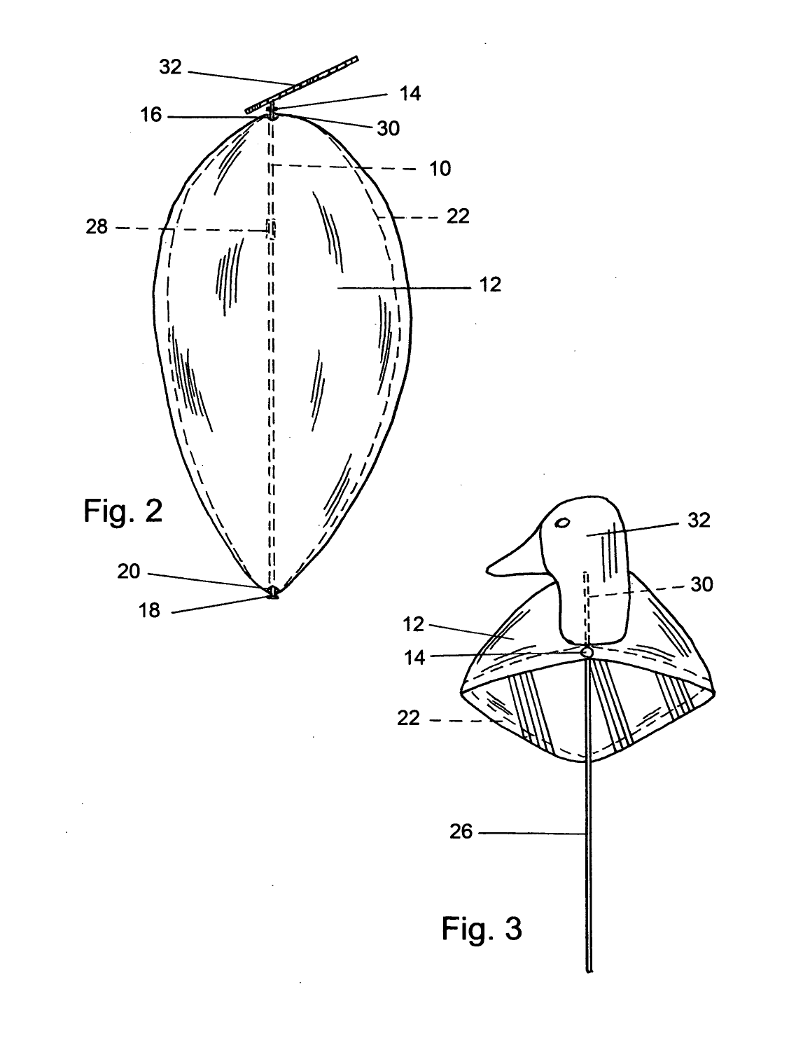

FIG. 2 is an overhead view of the invention.

FIG. 3 is a frontal view of the invention.

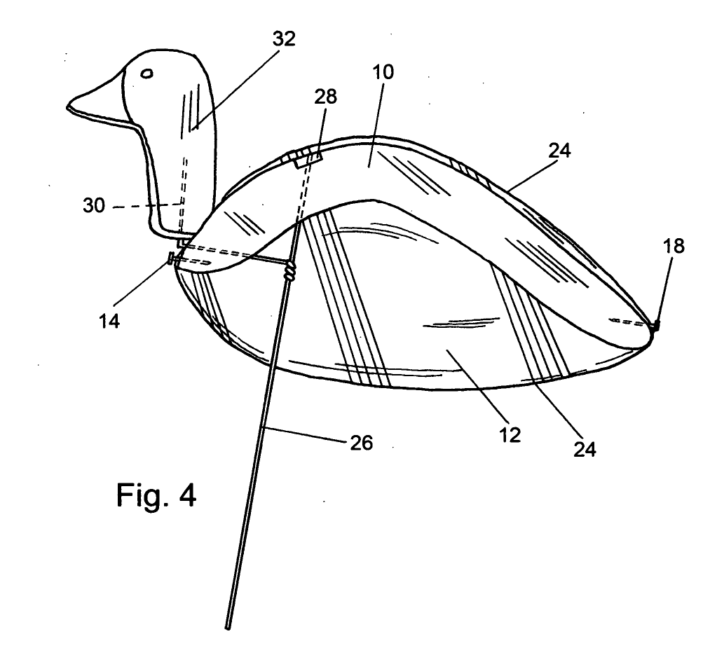

FIG. 4 is a side view of the invention in a storage position.

DRAWINGS - REFERENCE NUMERALS

| | |
|---|---|
| 10 | Body support member |
| 12 | Fabric body shell |
| 14 | Front body retention peg |
| 16 | Front mounting hole |
| 18 | Rear body retention peg |
| 20 | Rear mounting hole |
| 22 | Lower body support strap |
| 24 | Hemmed strap retention pocket |
| 26 | Ground stake |
| 28 | Protective plastic clip |
| 30 | Head support wire |
| 32 | Head structure |

### DETAILED DESCRIPTION

### Preferred Embodiment

A preferred embodiment of the invention is presented in FIG. 1. A fabric body shell 12 is attached to a body support member 10. The body support member 10 contains both a front body retention peg 14 and a rear body retention peg 18. The front body retention peg 14 and the rear body retention peg 18 are both operably removable. The fabric body shell 12 contains both a front mounting hole 16 and a rear mounting hole 20. The fabric shell body 12 is connected to the body support member 10 by inserting both the front body retention peg 14 through the front mounting hole 16 and the rear body retention peg 18 through the rear mounting hole 20. In the preferred embodiment of the invention, the fabric body shell will be manufactured out of flash spun high-density polyethylene fabric. The body support structure will consist of a corrugated plastic, however a plastic rib consisting of similar material can be used. The body retention pegs are made of an injection molded plastic, wood pegs can be used.

The fabric shell body 12 is supported outwardly at the bottom by a lower body support strap 22. The lower body support strap 22 is positioned inside a hemmed strap retention pocket 24, located within the fabric body shell 12. The lower body support strap 22 is threaded through the hemmed body strap retention pocket 24 and is held in place by a means of fastening. The body strap retention pocket 24 is a sewn in feature of the fabric shell body 12. In the preferred embodiment of the invention the body support strap is made of lightweight plastic strapping. A rubber or metal support strap can be used.

A ground stake 26 is inserted through the top of the body support member 10. A protective plastic clip 28 is affixed on top of the body support member 10 covering the top of the ground stake 26. The ground stake 26 is used to support the invention in the ground. In the preferred embodiment of the invention the ground stake is made of stainless steel. However, a plastic or fiberglass ground stake can be used.

A head support wire 30 is used to connect a head structure 32 to the decoy structure. The head support wire 30 consists of two ends, one of which is straight and the other contains a coiled end. The head support wire 30 is positioned at the front of the body support member 10 directly above the front body retention peg 14. The ground stake 26 is threaded through the coiled end of the head support wire 30 to form a connection. The head support wire 30 is inserted into the base of the head structure 32. The head support wire 30 is then bent into an upright position when the invention is in use. In the preferred embodiment the head support wire is stainless steel.

FIG. 2 shows the relationship of the body support member 10 to the fabric body shell 12. The front body retention peg 14 and rear body retention peg 18 anchor each end of the fabric body shell 12. The lower body support strap 22 is positioned around the circumference of the fabric body shell, and is held in place below the front body retention peg 14 and the rear body retention peg 18. the preferred embodiment of the invention, the length of the lower body support strap 22 is nominally shorter than the circumference of the base of the fabric shell body 12.

In the preferred embodiment of the decoy the open bottom of the fabric shell body 12 is angled upward to capture head on wind. FIG. 3 is a frontal view of the invention and demonstrates the open bottom of the fabric shell body 12.

In the preferred embodiment of the invention, the decoy is stored by rotating the fabric shell body 12 about an axis between the front body retention 14 and the rear body retention peg 18. Shown in FIG. 4. The body support member 10 remains in position. The head structure 32 is positioned in a parallel plane for storage.

1. A hunting decoy for the purpose of attracting waterfowl, comprising:
(a) a fabric material body structure,
(b) a lateral support incorporated in said body structure as a means to facilitate expansion of said body structure,
(c) a horizontal body support member as a means of providing a structural backbone,
(d) wherein said body structure is substantially open on the underside as a result of a combination of said support device and said support member,
(e) a means for connecting said body, with said support, to said member,
(f) a head structure, consisting of a head and a neck portion,
(g) a means of connecting said head structure to said member comprising of a head support wire, consisting of two ends, one end of said wire is straight to facilitate connection to said head structure, and one end of said wire is a coiled connective end to facilitate connection to a wire ground stake,
(h) a wire ground stake for supporting said decoy invention and as a means for inserting and securing said structure to the ground, whereby the resulting decoy provides a hunter with a life-like fabric decoy representing a fowl that will not collect precipitation inside of said structure.

2. The hunting decoy of claim 1 wherein said head structure is substantially adjustable.

3. The hunting decoy of claim 1 wherein said body structure is rotatable around a rotational axis of said support member and said connecting means for the purpose of storage.
